(19) United States
(12) Patent Application Publication
(10) Pub. No.: US 2016/0105010 A1
(43) Pub. Date: Apr. 14, 2016

(54) Repairable Power Loop (Cord) Assembly

(71) Applicant: Southern Technical Control, LLC, Corpuis Christi, TX (US)

(72) Inventors: Wesley McKinney, Corpus Christi, TX (US); Brad Sinor, Corpus Christi, TX (US); Cliff Grubbs, Corpus Christi, TX (US); Eddie Cardoshinsky, Corpus Christi, TX (US); Jason Ardoin, Corpus Christi, TX (US); Brian Parker, Corpus Christi, TX (US)

(21) Appl. No.: 14/878,560

(22) Filed: Oct. 8, 2015

Related U.S. Application Data
(60) Provisional application No. 62/061,937, filed on Oct. 9, 2014.

(51) Int. Cl. H02G 3/04; H02G 1/00; H02G 9/06

(52) U.S. Cl. CPC H02G 3/0481; H02G 3/0406; H02G 9/06; H02G 1/00

(57) ABSTRACT

A power cord assembly for supplying power to a drilling rig is disclosed. The assembly is assembled such that it can be easily dismantled for infield repairs and replacement of a malfunctioning component, hence it is a re-buildable unit. A series of cords containing a stack of cables that supply power to the Top Drive unit are secured in position within a hose, by several compression blocks. The compression blocks are concentric to each other about an axis. A hanging system surrounds the compression blocks and the hanging system is further surrounded by a hose. A series of king clamps are placed around the hose for firmly securing the hose in its position. The king clamps are removed when needed (for example for repair of a cable) so that all the components which make up the assembly are easily accessed by a user. The assembly is secured to a drilling rig and goes up and down in a continuous fashion during use.

### CROSS REFERENCE TO RELATED APPLICATION(S)

This is a non-provisional patent application based on co-pending U.S. Provisional Patent Application Ser. No. 62/061,937 (Attorney Docket No. STC-14-1) previously titled “Repairable Power Loop (Cord) Assembly”, filed on Oct. 9, 2014, the priority of which is hereby claimed and the disclosure of which is incorporated herein by reference in its entirety.

### BACKGROUND

1. Field of the Invention

The present invention relates to an assembly to supply power to electrical equipment used in a wellbore drilling operation. More particularly, the present invention relates to a repairable power cord assembly which can be repaired or rebuilt on site of the drilling operations, in case of a malfunction.

2. Description of the Related Art

Electrical power is necessary for wellbore drilling as many components and devices require continuous electric power during various stages of a drilling operation. Various applications that include equipment, such as AC (alternating current) and DC (direct current) electric motors, sensors and transmitters are required to monitor the temperatures, pressure, fluids, and environment in the bore well. Electrical Motors power gears of a top drive unit to rotate drilling bits in the exploration process, while pumps are required to pump in drilling or completion fluids into the bore well and also for extracting drilling fluid from the bore well. In oil well operations, data is collected and analysed using various control systems, which helps process engineers and operators in process control so that they can make production decisions for optimization of the process. Hence supply of the continuous electrical current is essential for a drilling rig operation and production. The power is supplied by a power source and power cord assembly attached to the source, to facilitate smooth functioning of the rig operation. There may be times or necessity that several power cord assemblies and sources, are needed for the operation of the rig.

In current industrial practice, the cables in the power cord assembly are placed within a flexible conduit for protection. Mounting flanges used are generally permanent and crimped on the flexible conduit used to secure the conduit to a fixed or moving piece of equipment requiring electrical current. The conduit is filled with potting compounds, for example a poop-like substance, when cured transforms into a semi solid form, which is also used for insulation and structural support, thereby holding power cables, control cables, and conduit for the entire assembly together. Once this potting compound has been installed and cured, it becomes impossible to access any of the cords placed in the conduit, thereby eliminating any ease to dismantle the assembly for repair without damaging the entire assembly. The replacement project is a time consuming process and generally shuts down the entire rig operation for a period of time.

Whenever the power cord assembly bends during operation (e.g., caused by the vertical reciprocation of the top-drive assembly), stresses occur in the power cable. Stressing the cables eventually leads to failure. The conventional design prohibits the repairing of the cables traveling through the conduit, if it is a single failure or multiple. The conventional design must be discarded and replaced with a new one. The replacement project is a time consuming process and generally shuts down the entire rig operation for a period of time.

Various methods have been used in the past to repair or replace the power cord assembly. The power cord assembly is connected to an umbilical through which the assembly receives electricity from a platform above. The major challenge is to maintain the physical integrity of the assembly while replacing the cords. A consistent diameter is critical for deployment and installation of the umbilical, strength is critical for deployment and through-life operations, and watertight integrity is critical for long and reliable operations. Because of the current set-up and hardened potting compound around the cables, it becomes difficult to maintain and repair damage to the power cord due to any malfunction. The rig operation has to be completely stopped to rectify the fault. It is a costly and time consuming process, which hampers production efficiency.

When making changes to the assembly, it remains important that the assembly be flexible, fire and oil/abrasion resistant, or has the assembly protected from fire and oil/abrasion as much as possible.

European Patent No. 2,567,386 by Matthew Bodziony, Walter Constantine, Damian Billeaudeau and Almir Fonseca Menezes discloses a power cable for a top drive drilling rig. Another European Patent No. 2,115,093 by discloses Franco Galletti and Redondo Eduardo Grizante disclose a power transmission cable. US Publication No. 2013/0062093 by Matthew Bodziony, Walter Constantine, Damian Billeaudeau and Almir Fonseca Menezes discloses a top drive power cable. U.S. Pat. No. 2,834,575 by Ardell Hughes discloses a power and transmission assembly for drilling rigs. NOV 3TDP0146 Document number 124975 is a publication which discloses a power cable for a TDS11 Top Drive cable useful in a rig with integrated VFD.

In light of the foregoing discussion, there remains a need for an innovative power cord assembly which is easy to install and repair and/or replace such that any down time for the drilling rig is minimized.

### SUMMARY

An object of the present invention is to provide an easily repairable power cord assembly used in a drilling rig operation.

According to an embodiment of the present invention, the power cord assembly includes a concentric arrangement of various components which are removably attached to one another. The subject assembly comprises a plurality of cables stacked and placed inside a plurality of cords. The cords pass through a first compression block which is further circumferentially surrounded by another compression block. A hanging system encircles the compression block. The hanging system is made of a top funnel and a bottom funnel secured together to assist in holding the assembly and carrying the weight thereof. A hose or sheath forms an outer covering of the hanging system and is present throughout the length of the hanging system. An embodiment of the present invention provides a plurality of king clamps and D-rings that are placed around the hose so that the hose is firmly held in its position.

### BRIEF DESCRIPTION OF DRAWINGS

The features of the present invention are set forth with particularity in the appended claims. Embodiments of the present invention will hereinafter be described in conjunction with the appended drawings provided to illustrate and not to limit the scope of the claims, wherein like designations denote like elements, and in which:

FIG. 1 shows an exploded perspective view of a power cord assembly;

FIG. 2 shows a front view of the power cord assembly;

FIG. 3a shows a top funnel of a hanging system of the power cord assembly;

FIG. 3b shows a bottom funnel of the hanging system of the power cord assembly;

FIG. 4 shows a side view of the assembly with cords inside, and

FIG. 5 shows a front view of the assembly with cords inside.

### DETAILED DESCRIPTION OF EMBODIMENTS

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention.

There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components which constitutes a power cord assembly used for supplying power to a top drive unit of a drilling rig. Accordingly, the components and the method steps have been represented, showing only specific details that are pertinent for an understanding of the present invention so as not to obscure the disclosure with details that will be readily apparent to those with ordinary skill in the art having the benefit of the description herein.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

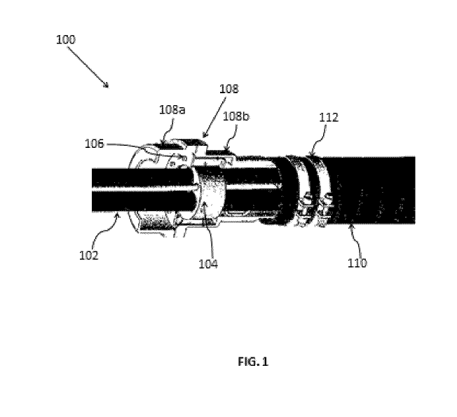

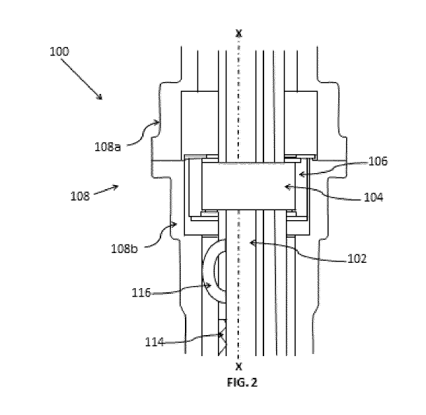

A power cord assembly 100 of a power transmission line to be used for supplying power to a top drive unit of a drilling rig is shown in FIG. 1 and FIG. 2. It should be appreciated that multiple power cord assemblies 100 can be combined together to form an entire power transmission line. The power cord assembly 100 connects to a power source which ultimately supplies electric power to a drilling rig. The power cord assembly 100 is designed in such a way that the power cord assembly 100 can be dismantled in case of fault or failure of any part along the length of the entire power transmission line. The dismantling of the power cord assembly 100 allows easy access to all the components of the power cord assembly 100. The power cord assembly 100 allows repair or replacement of the damaged parts, specifically on the job site, or drill rig site. Further, once the repair is performed, the power cord assembly 100 can be easily reassembled back to the original structure.

Often, the power cord assembly 100 is placed or suspended, about a third of the way up the derrick of the drill site, and secured to the side walls of the derrick. Depending on what is needed, the repair of the power cord assembly 100 may necessitate removal from the derrick. It is important that the power cord assembly 100 maintain its flexibility and integrity during use as well as after any repair, so as to not stress the power cords inside and cause further damage.

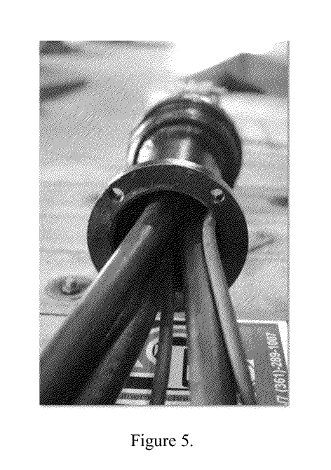

The power cord assembly 100 includes at least one, and generally a plurality of cords 102, at least one, and generally a plurality of cables shown in FIGS. 4 and 5 placed inside each of the cords 102, a first compression block 104, a second compression block 106, which is or can be a portion of the hanging system or funnel 108, a hanging funnel system 108, a hose 110 and at least one, and generally plurality of king clamps 112 as shown in FIGS. 1 and 2. An exploded perspective view of the power cord assembly 100 is shown in FIG. 1. Each of the cables are configured to provide power supply to different equipment present at different locations in the drilling rig.

According to an embodiment of the disclosure as shown in FIG. 1, the first compression block 104 includes at least one and generally a plurality of circular openings (not shown). The plurality of or multiple cords 102 pass through the circular openings. It should be appreciated that the first compression block 104 is preferably circular in shape. The first compression block 104 is circumferentially surrounded by the compression block 106 such that the first compression block 104 and the compression block 106 are concentric about a longitudinal axis X-X as shown in FIG. 2. After the installation of block 106 around the first compression block 104, the second compression block 106 compresses and firmly holds the first compression block 104 so as to further secure the cords 102 held by the first compression block 104. The second compression block 106 also keeps water, fluids, and debris away from the cords 102 at all times. The first compression block 104 and the second compression block 106 can be easily dismantled when required. The first compression block 104 is made of a suitable material, such as rubber. The second compression block 106 is a commercially available mechanical rubber seal. The mechanical rubber seal is compressed by compression nuts and bolts, rubber and two metal plates squeezing the two rubber pieces together and tightened to the specified torque settings. In an example, the maximum torque value is 7 (Newton Meter). It should be appreciated that in another embodiment, an equivalent seal can be used as the second compression block 106. Roxtec® is a suggested manufacturer for the purchase of the hanging system 108.

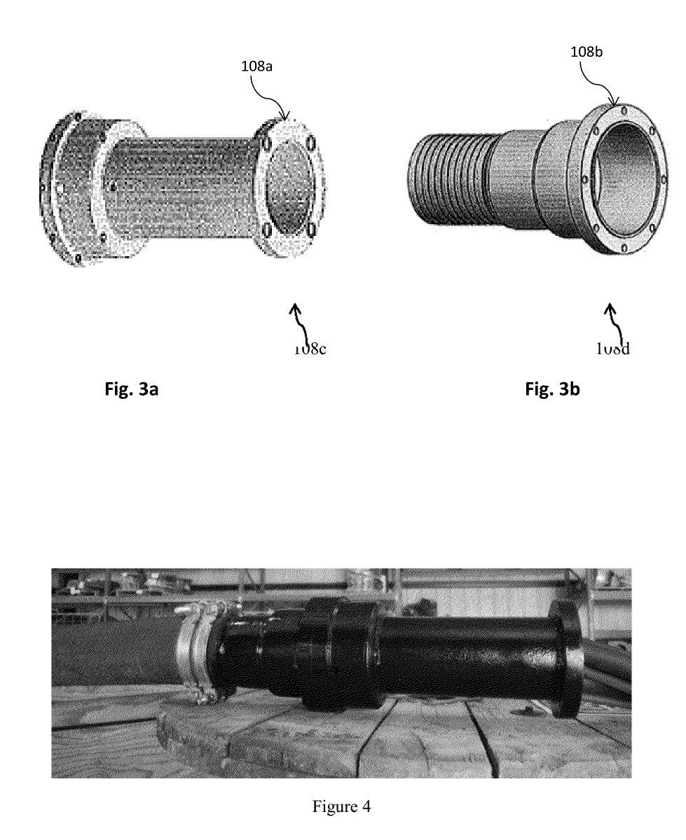

The hanging system 108 is a cylindrical structure and is made of multiple or a plurality of parts as shown in FIG. 3a and FIG. 3b. FIG. 3a shows a top funnel of the hanging system 108. FIG. 3b shows a bottom funnel of the hanging system 108. The hanging system or hanging assembly 108 is also called as funnel assembly 108 (hereinafter the hanging assembly 108 and funnel assembly 108 are interchangeably used). In an example of the invention, the plurality of parts includes a first part 108a, a second part 108b, a third part 108c and a fourth part 108d. The first part 108a and the third part 108c are tied together to form the top funnel, while the second part 108b and the fourth part 108d are tied together to form the bottom funnel. The top funnel and the bottom funnel are removably attached and adjacent to one another. The top funnel fits into the bottom funnel forming the second compression block 106 holding the cords 102. Block 106 is integral with funnel 108 and surrounds block 104. This can be a separate or integral unit. The hanging system 108 is configured to be dismantled when needed so that the first compression block 104, the second compression block 106 and the cords 102 can be easily accessed. The second compression block 106 contains a series of nuts and bolts (not shown in figures). The nuts and bolts are used to compress and secure the second compression block onto or over the first compression block 104.

In another embodiment, the multiple parts of the hanging system 108 can be more than or less than four. The first part 108a, the second part 108b, the third part 108c and the fourth part 108d which comprises hanging system 108 which make up the top drive connection point and derrick hanging point. The derrick hanging point is supplied by the drilling company that is already in place and the power cord assembly 100 conforms to meet the requirement of the derrick hanging point. As the power cord assembly 100 is suspended above the ground, the hanging system 108 provides a suspension point from where a suspension cable suspended from the top of a derrick connects to the hanging system 108 and holds the power cord assembly 100 in its position. The top funnel and the bottom funnel of the hanging system 108 are bolted with one another with Schedule 80 bolts or the like, and wired together by using a safety wire. The Schedule 80 bolts are tightened to hold the weight of the power cord assembly 100 thereby securing the cords 102. In an embodiment each of Schedule 80 bolts is an aircraft stainless steel type bolt which have pre drilled holes in their head and all bolts are lock wired to each other. By making this at least a four piece product it provides easy access, easy break down and reassembly of the power cord assembly 100. The hanging system 108 is dismantled by cutting the safety wire, removing the Schedule 80 bolts and pulling apart the first part 108a, the second part 108b, the third part 108c and the fourth part 108d.

The first compression block 104 and hanging system 108 can be easily dismantled and are utilized in place of conventional potting compound to close up the power cord assembly 100. This makes the power cord assembly 100 fully repairable when any damage occurs. The hanging system 108 is used to quickly break apart the power cord assembly 100. The hanging system 108 also prevents the internal components from twisting or breaking during vibrations.

The hanging system 108 is further surrounded by the hose 110. It should be appreciated that the hose 110 can also called a sheath 110. The hose 110 is preferably flexible material made of rubber which is oil/abrasion resistant. In an embodiment, the hose 110 is made of nitrile rubber or a polymeric material made from cross-linked olefin resin. The hose 110 has thickness range of about one to sixteen inches. The hose 110 is used as an outer protective cover for the elements within the power cord assembly 100. The hose 110 keeps the water and debris away from the internal element of the power cord assembly 100 and keeps them all in one piece. The hose 110 extends throughout the length of the hanging system 108. The hose 110 is configured to protect the power cord assembly 100 from harsh conditions experienced during drilling operations. The hose 110 is secured in its position with the help of at least one, generally plurality of king clamps 112. The plurality of king clamps 112 used are preferably galvanized. The diameter of the hose 110 as used in drilling operations is about 3/16 inch.

The power cord assembly 100 further includes a D ring 114 and an offset strain relief 116. The D ring 114 helps support the weight of the cords 102 that are in the power cord assembly 100. The D ring 116 is preferably made of stainless steel material making it anti-corrosive and stronger to withhold the weight of the plurality of cords 102. The offset strain relief 116 is attached to the plurality of cords 102. The offset strain relief 116 is attached to the D ring 114 and is set to the required length. As per the arrangement of all the elements of the power cord assembly 100, the hose 110 has to sustain the weight of the power cord assembly 100 as it is the outer most element of the power cord assembly 100. The offset strain relief 116 and a quick link (not shown) aid to take the weight off the power cord assembly off the hose 110. The offset strain relief 116 and the quick link also aid to take the pressure off the plurality of cords 102 from sliding back in the loop. The offset strain relief 116 and the quick link hold the pressure of the plurality of cords 102 not allowing them to move inward. Once the cords 102 are set in the D ring 114 with the offset strain relief 116, the cords 102 cannot move and are set to the required length. The cords 102 are secured in their position by the offset strain relief 114 and the quick link. The quick link has an opening width of about ⅜ inch. The king clamps 112 are mechanical seal clamps installed to secure the hose 110 in its position. The king clamp 112 allows easy replacement of the hose 110 in the event of failure or need of repair. The D ring 116 is preferably made of stainless steel material making it anti-corrosive and stronger to withhold the weight of the power cord assembly 100. All the elements of the power cord assembly 100 according to an embodiment of the current disclosure are essentially fixed with sufficient flexibility to maintain the integrity of the power cord assembly 100.

Blocks 104 and 106 surround and secure the cords 102 and keep water, fluids, and debris out of the power cord assembly 100. As an alternative to making repairs on-site, the power cord assembly 100 can be removed and returned to the manufacturer or provider for repair off site. The use of the hanging system 108 with the first compression block 104 and the hanging funnel system 108, which can include the compression block 106 allows the power cord assembly 100 to be disassembled and repaired. It is noted the blocks can be separate or integral with the power cord assembly.

Historically, standard commercial assembly loops use a standard commercially available flange with a permanent crimp fitting, together with potting compound placed inside the hose, to secure the cords or cable(s) inside of the assembly. Once the potting compound dries inside of the hose, the assembly is fixed and unable to be disassembled. Because the standard flange crimp is permanent, it tends to destroy the integrity of the securing method if tampered with or altered. The potting compound hardens on the inside of the assembly into essentially one hard piece, thus making the assembly not repairable.

The present invention as shown in FIG. 4 and FIG. 5 illustrates a side and top view of the assembly prior to use. The assembly does not use standard permanent crimp fitting flanges, nor does it utilize potting compound to secure the plurality of cords 102 within the hose 110. The first compression block 104, the second compression block portion 106 (which is integral or separate from funnel 108) and the plurality of king clamps 112 make all the elements of the power cord assembly 100 accessible. The first compression block 104 and the second compression block portion 106 also securely hold the plurality of cords 102 in place as needed. The bolts of 106 secure the compression block around the cables. The power cord assembly 100 has no potting compound within the assembly. The first compression block 104 holds the cords 102 without any use of the potting compound. Block 104 can have as many openings to hold as many cables as desired.

### EXAMPLE 1

As an illustrative example of the current invention, if a common failure occurs in the power cord assembly 100, i.e. one of the pluralities of power cord 102 or cables is not working, a technician can disassemble the unit and test the power cords 102. When the damaged power cord 102 is found, a new power cord(s) 102 will be brought to the rig location for replacement. Only the malfunctioning cord or cords 102 that is faulty will be replaced with a new one. The power cord assembly 100 allows a user to dismantle the hanging system 108, the second compression block 106 and the first compression block 104 and access the multiple power cords 102. The power cord assembly 100 allows the user to successfully replace only the faulty piece i.e., one of the pluralities of power cord 102 as stated in this scenario. After replacement of the faulty piece the power cord assembly 100 is again reassembled. This saves time and cost of having to buy an entire new power cord assembly 100 when only one of the elements of the power cord assembly 100 malfunction.

### EXAMPLE 2

An assembly loop was placed in service wherein it was used to drill an oil well hole on location. It was monitored for 28 days. For the first month (28 days) the values were documented and shown in Table 1. The service loop travelled up the derrick and back down the derrick a total of 2338 times with no issues. Table 1 shows data for the well hole which represents a completed job and the number of times the equipment travelled up and down the derrick. This data is a representative table of 2 other well holes drilled and monitored while using a service loop. It was found that all functions of the loop (or assembly) worked as designed with no modifications, or interruptions of power found. Two other oil wells were monitored and had the assembly travel up and down the derrick with no interruption of power found.

TABLE 1
Drilling Activity for Service Loop 28 days

| Hole #1 | Feet |
|---|---|
| A. Trip Footage | 130497 |
| B. Drilling Footage | 17267 |
| C. Remaining Footage | 0 |
| D. Casing Footage | 11057 |
| E. Lay down/Picking up Pipe | 17394 |
| F. Service loop Travel Up | 2338 times |
| G. Service loop Travel Down | 2338 Times |

Definitions:
A. means how many pieces of pipe tripped out of the well hole;
B. means how deep the assembly when down the well hole;
C. means how many feet are left to go down.
0 means the hole is completed.
D. means how many feet down the cement is set.
E. means how far down the assembly went into the well hole.
F. and G mean how many times the assembly loop traveled up and down the derrick.

After the 28 days, the loop was returned to the facility and tested for any issues. The system was disassembled and evaluated. It was found that no issues were recorded or observed, and the loop functioned as designed with no down time due to power failure, or failure of the inventive assembly. All factors were considered, e.g., ease of break down, weak points, cable integrity, product reliability and the like. All functions of the loop worked as designed while on the derrick, or in other words, all inner components were maintained intact over the 28 days and 2338 travel times.

There is no comparative data available since the standard practice is to replace an entire assembly when damaged (even if only 1 cord is damaged).

It was found that the inventive assembly fit within the O.E.M. bracket, and the bell housing assemblies will not impact any clearances or drilling operations. The experimental unit is durable and made from 1026 seamless steel tubing. The outer protective hose is constructed of thick walls and can withstand aggressive environmental conditions as seen in oil well hole operations. The two piece housing design is safe and within API standards and the top and bottom portion of the housing/hanger assembly can be secured using quantity 8, ⅜″ Grade-8 bolts, with safety wire. The individual load rating of a single ⅜″ Grade 8 bolt provides ample coverage of the load it is bearing.

The length can be customized as desired, but representative lengths of the power loop are 86 feet and 135 feet.

The present invention has been described herein with reference to a particular embodiment for a particular application. Although selected embodiments have been illustrated and described in detail, it may be understood that various substitutions and alterations are possible. Those having ordinary skill in the art and access to the present teachings may recognize additional various substitutions and alterations are also possible without departing from the spirit and scope of the present invention, and as defined by the following claim.

What is claimed is:

1. A power cord assembly for use in a drilling rig, the power cord assembly comprising:
at least one cord which comprises at least one power cable for supplying power to the drilling rig;
a first compression block, wherein the first compression block is circular in shape and allows passage of the cord there through;
a second compression block circumferentially surrounding the first compression block, such that the first compression block and the second compression block are concentrically placed about an axis passing through the center of the first compression block;
a hanging system circumferentially surrounding the second compression block, wherein the hanging system has the cable therein and can be dismantled to access the first compression block, the second compression block and the plurality of cables therefrom;
a hose circumferentially surrounding the hanging system throughout the length of the hanging system, wherein the hose provides outer covering to the power cord assembly; and
at least one clamp encircling the outside of the hose, wherein the clamp secures the hose to the hanging system.

2. The power cord assembly according to claim 1, wherein the first compression block is made of rubber.

3. The power cord assembly according to claim 1, wherein the hanging system is made of a top funnel and a bottom funnel.

4. The power cord assembly according to claim 1, wherein the second compression block is a mechanical compression seal and is integral with the hanging system.

5. The power cord assembly according to claim 1 further including at least one offset strain relief.

6. The power cord assembly according to claim 1, wherein the diameter of the hose is about 3/16 inches.

7. The power cord assembly according to claim 1, wherein the king clamp is a mechanical clamping device.

8. The power cord assembly according to claim 1, wherein the king clamp is a galvanized king clamp.

9. The power cord assembly according to claim 1 further including at least one D-ring support.

10. A method of supplying electric power to an oil drilling rig having a derrick wherein the method comprises the steps of:
a. providing an assembly in accordance with claim 1;
b. securing the assembly to an oil drilling rig-derrick unit; and,
c. connecting the assembly to a power source.

11. The method of claim 14 wherein the assembly secured to the drilling rig derrick unit goes up and down the derrick in a continuous fashion.
